(19) United States
(12) Patent Application Publication
(10) Pub. No.: US 2015/0091851 A1
(43) Pub. Date: Apr. 2, 2015

(54) SIMULTANEOUS DISPLAY UPDATING AND CAPACITIVE SENSING FOR AN INTEGRATED DEVICE

(71) Applicant: Synaptics Incorporated, San Jose, CA (US)

(72) Inventor: Joseph Kurth REYNOLDS, Alviso, CA (US)

(73) Assignee: Synaptics Incorporated, San Jose, CA (US)

(21) Appl. No.: 14/283,201

(22) Filed: May 20, 2014

Related U.S. Application Data
(60) Provisional application No. 61/886,019, filed on Oct. 2, 2013.

(51) Int. Cl. G06F 3/044; G06F 3/041

(52) U.S. Cl. CPC G06F 3/044; G06F 3/0412; G06F 2203/04104
USPC 345/174

(57) ABSTRACT

Embodiments of the invention generally provide an input device with an integrated display that drives a capacitance sensing signal on a sensor electrode in parallel with driving a display signal onto a display electrode. To mitigate the interference between the two signals, the input device synchronizes the frequency of the capacitance sensing signal to a line rate used when performing display updating—i.e., the time period used by the integrated display to update a row of pixels. In one example, the capacitance sensing cycles includes a plurality of sensing cycles. The time period of the sensing cycles may be synchronized with the line rate. In addition, in one embodiment, the input device may phase align the capacitance sensing signal with a periodic noise event in the display signal such as a voltage transition, charge share event, and the like.

### CROSS-REFERENCE TO RELATED APPLICATIONS

This application claims benefit of U.S. provisional patent application Ser. No. 61/886,019, filed Oct. 2, 2013 entitled “Simultaneous Display Updating and Capacitive Sensing for an Integrated Device”, which is herein incorporated by reference.

### BACKGROUND OF THE INVENTION

1. Field of the Invention

Embodiments of the present invention generally relate to a method and apparatus for performing capacitive sensing and display updating in parallel, and more specifically, to synchronizing a capacitive sensing signal to a line rate used when updating a display.

2. Description of the Related Art

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### SUMMARY OF THE INVENTION

One embodiment described herein is an input device that includes a plurality of display electrodes, a plurality of sensor electrodes display, and a processing system coupled to the plurality of sensor and display electrodes. The processing system is configured to drive a capacitive sensing signal onto at least one of the plurality of sensor electrodes and drive a display signal onto at least one of the plurality of display electrodes for updating the display. Furthermore, the capacitive sensing signal and the display signal are driven in parallel for at least some period of time and a frequency of the capacitive sensing signal is synchronized to a line rate used by the display module when updating the display.

Another embodiment described herein is a processing system that includes a sensing module configured to drive a capacitive sensing signal onto at least one of a plurality of sensor electrodes and a display module configured to drive a display signal onto at least one of a plurality of display electrodes for updating a display. Moreover, the capacitive sensing signal and the display signal are driven in parallel for at least some period of time and a frequency of the capacitive sensing signal is synchronized to a line rate used by the display module when updating the display.

Another embodiment described herein is a method that drives a capacitive sensing signal onto at least one of a plurality of sensor electrodes and drives a display signal used for updating a display onto at least one of a plurality of display electrodes. Furthermore, the capacitive sensing signal and display signal are driven in parallel for at least some period of time and a frequency of the capacitive sensing signal is synchronized to a line rate used when updating the display.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of an exemplary input device, according to one embodiment described herein.

FIGS. 2A-2B illustrate portions of exemplary patterns of sensing elements or capacitive sensing pixels, according to embodiments described herein.

FIG. 3 is a schematic block diagram of a display device, according to one embodiment described herein.

FIG. 4 illustrates a system for updating a source line in a display device, according to one embodiment described herein.

FIGS. 5A-5D illustrate inversion schemes for a display device, according to embodiments described herein.

FIGS. 6A-6B illustrate timing charts for synchronizing capacitive sensing with display updating, according to embodiments described herein.

FIG. 7 illustrates spatially separating capacitive sensing from active gate lines, according to one embodiment described herein.

FIGS. 8A-8D illustrate performing capacitive sensing in portions of a display spatially separated from active gate lines, according to embodiments described herein.

FIG. 9 illustrates a method for performing capacitive sensing and display updating in parallel, according to one embodiment described herein.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Various embodiments of the present technology provide input devices and methods for improving usability.

Capacitive sensing in an integrated display (i.e., a display that outputs images in addition to providing a capacitive sensing region) has many challenges including routing and signal settling which can cause deterioration of either the capacitive sensing performance (SNR) or the display performance (visible artifacts near sensor electrodes). For example, the selection and update of pixels in the integrated display can interfere electrically with the accurate measurement of charge coupling affected by an input object. One solution is to make the display update settling time and the touch sensing update settling time non-overlapping. Doing so avoids the electrical modulation (or change in impedance) of capacitive touch sensing from affecting the voltages or currents in the display pixels (e.g. while the source drivers are coupled to the pixels by the gate line selection) especially in overlapped/pipeline display update. But allowing simultaneous capacitive sensing and display updating can provide significantly improved performance and/or reduce panel requirements. These improvements are due to the significantly increased time that both capacitive sensing and display updating can be performed. This can be achieved by choosing appropriate update frequency, phase, and/or location of the capacitance sensing signal and display signals.

In one embodiment, an input device with an integrated display drives a capacitance sensing signal (e.g., a signal used to perform absolute capacitance sensing and/or transcapacitive sensing) on a sensor electrode in parallel with driving a display signal onto a display electrode. To mitigate the interference between the two signals, the input device synchronizes the frequency of the capacitance sensing signal to a line rate used when performing display updating—i.e., the time period used by the integrated display to update a row of pixels. In one example, the capacitance sensing cycles includes a plurality of sensing cycles that each contain two half cycles. The time period of the half cycles may be synchronized with the line rate.

In addition, in one embodiment, the input device may phase align the capacitance sensing signal with a periodic noise event in the display signal such as a voltage transition, charge share event, and the like. In one example, the input device may align a reset period associated with the capacitive sensing signal to the periodic noise event occurring in the display signal. In this manner, any noise generated by the noise event on the sensor electrode is ignored. By synchronizing and phase aligning the capacitance sensing signal and display signal, the input device may prevent the noise events from indicating a change of capacitance (which may be misinterpreted as being caused by an input object proximate to the integrated display) when the capacitance sensing signal is sampled and filtered.

In another embodiment, the input device may perform capacitance sensing on a sensor electrode that is spatially separated from a display electrode that is currently active. When updating the display, the input device may raster through each row consecutively by activating respective gate lines. To avoid interference between the signals on the gate lines and the capacitive sensing signal on a sensor electrode, the input device may perform capacitive sensing on a sensor electrode that is spatially separated from the active gate line where the device is currently updating the pixels. Furthermore, the input device may mitigate interference between the sensor electrode and other display electrodes (e.g., display electrodes different from the active gate line such as source lines or Vcom electrodes) by synchronizing and phase aligning the capacitance sensing signal to the display signals as mentioned above.

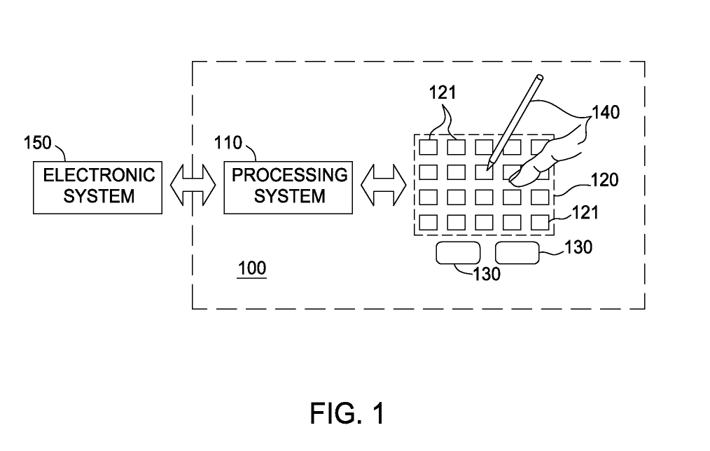

FIG. 1 is a block diagram of an exemplary input device 100, according to one embodiment presented herein. Although embodiments of the present disclosure may be utilized in an input device 100 including a display device integrated with a sensing device, it is contemplated that the invention may be embodied in display devices without integrated sensing devices. The input device 100 may be configured to provide input to an electronic system 150. As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system 150, or can be physically separate from the electronic system 150. As appropriate, the input device 100 may communicate with parts of the electronic system 150 using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1.

Sensing region 120 encompasses any space above, behind, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements 121 for detecting user input. As several non-limiting examples, the input device 100 may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements 121 pick up loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements 121 to create electric fields. In some capacitive implementations, separate sensing elements 121 may be ohmically shorted together to form larger sensor electrodes. Some capacitive implementations utilize resistive sheets, which may be uniformly resistive. Although not shown, the sensing elements 121 may be capacitive sensing pixels that include one or more sensor or other electrodes.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. The change in capacitive coupling may be between sensor electrodes in two different sensing elements 121 or between two different sensor electrodes in the same sensing element 121. In various embodiments, an input object near the sensor electrodes alters the electric field between the sensor electrodes, thus changing the measured capacitive coupling. In one implementation, a transcapacitance sensing method operates by detecting the capacitive coupling between one or more transmitter sensor electrodes (also “transmitter electrodes”) and one or more receiver sensor electrodes (also “receiver electrodes”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitter electrodes or receiver electrodes, or may be configured to both transmit and receive.

In FIG. 1, a processing system 110 is shown as part of the input device 100. The processing system 110 is configured to operate the hardware of the input device 100 to detect input in the sensing region 120. The processing system 110 comprises parts of or all of one or more integrated circuits (ICs) and/or other circuitry components. (For example, a processing system for a mutual capacitance sensor device may comprise transmitter circuitry configured to transmit signals with transmitter sensor electrodes, and/or receiver circuitry configured to receive signals with receiver sensor electrodes). In some embodiments, the processing system 110 also comprises electronically-readable instructions, such as firmware code, software code, and/or the like. In some embodiments, components composing the processing system 110 are located together, such as near sensing element(s) 121 of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen of the display device 101. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), electrowetting, MEMS, or other display technology. The input device 100 and the display device 101 may share physical elements. For example, some embodiments may utilize some of the same electrical components for displaying and sensing. As another example, the display device 101 may be operated in part or in total by the processing system 110.

It should be understood that while many embodiments of the present technology are described in the context of a fully functioning apparatus, the mechanisms of the present technology are capable of being distributed as a program product (e.g., software) in a variety of forms. For example, the mechanisms of the present technology may be implemented and distributed as a software program on information bearing media that are readable by electronic processors (e.g., non-transitory computer-readable and/or recordable/writable information bearing media readable by the processing system 110). Additionally, the embodiments of the present technology apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

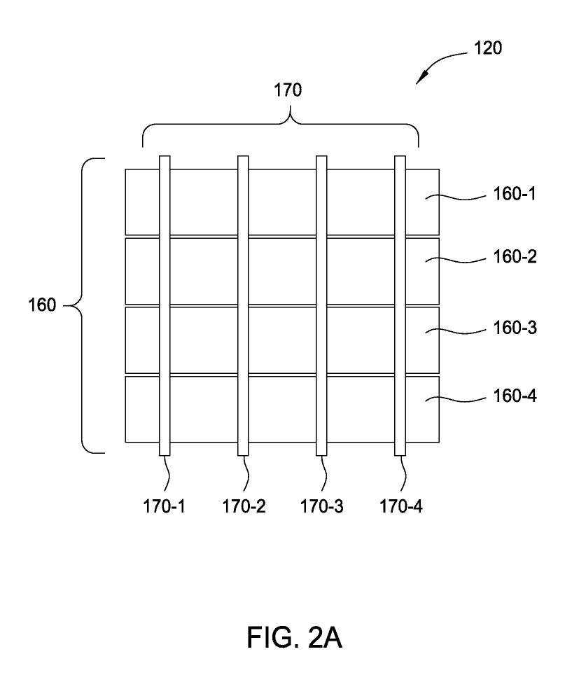

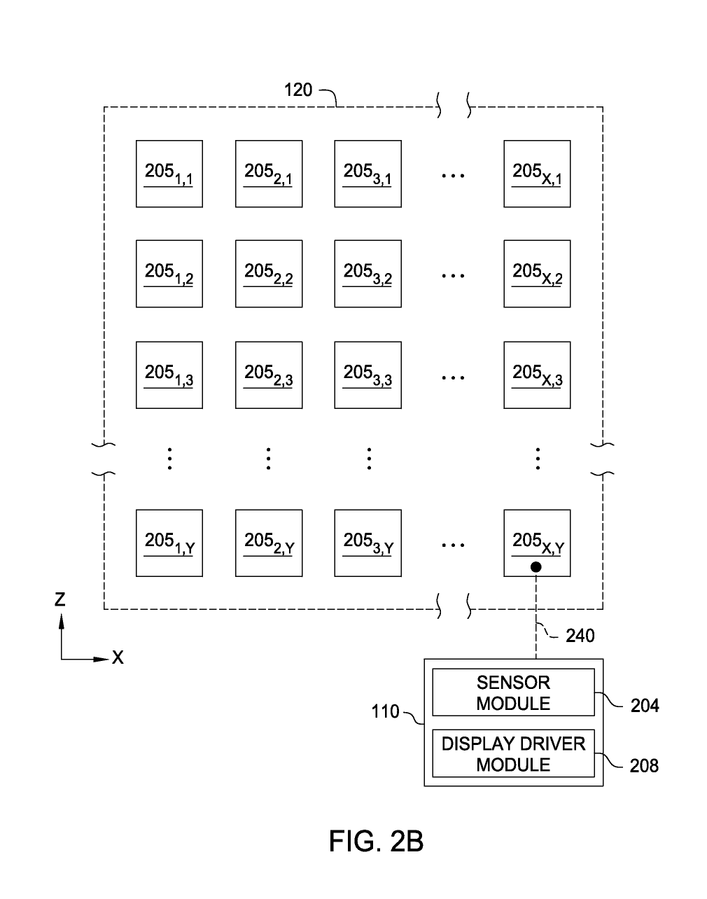

FIG. 2A shows a portion of an exemplary pattern of sensing elements configured to sense in a sensing region 120 associated with the pattern, according to some embodiments. For clarity of illustration and description, FIG. 2A shows the sensing elements in a pattern of simple rectangles, and does not show various components. This pattern of sensing elements comprises a first plurality of sensor electrodes 160 (160-1, 160-2, 160-3, . . . 160-n), and a second plurality of sensor electrodes 170 (170-1, 170-2, 170-3, . . . 170-n) disposed over the plurality of sensor electrodes 160. In one embodiment, this pattern of sensing elements comprises a plurality of transmitter electrodes 160 (160-1, 160-2, 160-3, . . . 160-n), and a plurality of receiver electrodes 170 (170-1, 170-2, 170-3, . . . 170-n) disposed over the plurality of transmitter electrodes 160. In another embodiment, the first plurality of sensor electrodes may be configured to transmit and receive and the second plurality of sensor electrodes may also be configured to transmit and receive.

Transmitter electrodes 160 and receiver electrodes 170 are typically ohmically isolated from each other. That is, one or more insulators separate transmitter electrodes 160 and receiver electrodes 170 and prevent them from electrically shorting to each other. In some embodiments, transmitter electrodes 160 and receiver electrodes 170 are separated by insulative material disposed between them at cross-over areas; in such constructions, the transmitter electrodes 160 and/or receiver electrodes 170 may be formed with jumpers connecting different portions of the same electrode. In some embodiments, transmitter electrodes 160 and receiver electrodes 170 are separated by one or more layers of insulative material. In such embodiments, the transmitter electrodes and receiver electrodes may be disposed on separate layers of a common substrate. In some other embodiments, transmitter electrodes 160 and receiver electrodes 170 are separated by one or more substrates; for example, they may be disposed on opposite sides of the same substrate, or on different substrates that are laminated together.

The areas of localized capacitive coupling between transmitter electrodes 160 and receiver electrodes 170 may be termed “capacitive pixels.” The capacitive coupling between the transmitter electrodes 160 and receiver electrodes 170 change with the proximity and motion of input objects in the sensing region associated with the transmitter electrodes 160 and receiver electrodes 170.

In some embodiments, the sensor pattern is “scanned” to determine these capacitive couplings. That is, the transmitter electrodes 160 are driven to transmit transmitter signals. Transmitters may be operated such that one transmitter electrode transmits at one time, or multiple transmitter electrodes transmit at the same time. Where multiple transmitter electrodes transmit simultaneously, these multiple transmitter electrodes may transmit the same transmitter signal and effectively produce an effectively larger transmitter electrode, or these multiple transmitter electrodes may transmit different transmitter signals. For example, multiple transmitter electrodes may transmit different transmitter signals according to one or more coding schemes that enable their combined effects on the resulting signals of receiver electrodes 170 to be independently determined.

The receiver sensor electrodes 170 may be operated singly or multiply to acquire resulting signals. The resulting signals may be used to determine measurements of the capacitive couplings at the capacitive pixels.

A set of measurements from the capacitive pixels form a “capacitive image” (also “capacitive frame”) representative of the capacitive couplings at the pixels. Multiple capacitive images may be acquired over multiple time periods, and differences between them used to derive information about input in the sensing region. For example, successive capacitive images acquired over successive periods of time can be used to track the motion(s) of one or more input objects entering, exiting, and within the sensing region.

The baseline capacitance of a sensor device is the capacitive image associated with no input object in the sensing region. The baseline capacitance changes with the environment and operating conditions, and may be estimated in various ways. For example, some embodiments take “baseline images” when no input object is determined to be in the sensing region, and use those baseline images as estimates of their baseline capacitances.

Capacitive images can be adjusted for the baseline capacitance of the sensor device for more efficient processing. Some embodiments accomplish this by “baselining” measurements of the capacitive couplings at the capacitive pixels to produce a “baselined capacitive image.” That is, some embodiments compare the measurements forming a capacitance image with appropriate “baseline values” of a “baseline image” associated with those pixels, and determine changes from that baseline image.

In some touch screen embodiments, plurality of sensor electrodes 160 and/or the plurality of sensor electrodes 170 comprise one or more common electrodes (e.g., segments of a “V-com electrode”, source drive electrode, gate electrodes or other display electrodes) used in updating the display of the display screen. These common electrodes may be disposed on an appropriate display screen substrate. For example, the common electrodes may be disposed on the TFT glass in some display screens (e.g., In Plane Switching (IPS) or Plane to Line Switching (PLS)), on the bottom of the color filter glass of some display screens (e.g., Patterned Vertical Alignment (PVA) or Multi-domain Vertical Alignment (MVA)), etc. In such embodiments, the common electrode can also be referred to as a “combination electrode”, since it performs multiple functions. In various embodiments, each transmitter electrode 160 comprises one or more combination electrodes. In other embodiments, at least two transmitter electrodes 160 may share at least one combination electrode. Furthermore, in one embodiment both the transmitters electrodes 160 and the receiver electrodes 170 are both disposed within a display stack on the display screen substrate. Additionally, at least one of the transmitter and/or receiver electrodes 160, 170 in the display stack may comprise a combination electrode. However, in other embodiments, only the transmitter electrodes 160 or only the receiver electrodes 170 (but not both) are disposed within the display stack while other sensor electrodes are outside of the display stack (e.g., disposed on an opposite side of a color filter glass).

In various touch screen embodiments, the “capacitive frame rate” (the rate at which successive capacitive images are acquired) may be the same or be different from that of the “display frame rate” (the rate at which the display image is updated, including refreshing the screen to redisplay the same image). In some embodiments where the two rates differ, successive capacitive images are acquired at different display updating states, and the different display updating states may affect the capacitive images that are acquired. That is, display updating affects, in particular, the baseline capacitive image. In various embodiments, the display updating effect may be due to a change in capacitance or a change in injected charge while changes in capacitances are measured. Thus, if a first capacitive image is acquired when the display updating is at a first state, and a second capacitive image is acquired when the display updating is at a second state, the first and second capacitive images may differ due to differences in the background capacitive image associated with the display updating states, and not due to changes in the sensing region. This is more likely where the capacitive sensing and display updating electrodes are in close proximity to each other, or when they are shared (e.g. combination electrodes). In various embodiments, the capacitive frame rate is an integer multiple of the display frame rate. In other embodiments, the capacitive frame rate is a fractional multiple of the display frame rate. For example, for a display frame rate of 60 Hz, the capacitive frame rate may be any one of 120 Hz, 180 Hz, and 240 Hz. For example, if the display frame rate is 60 Hz, then the capacitive frame rate may be 90 Hz. However other display frame rates and capacitive frame rates are possible. In other embodiments, the capacitive frame rate is a fractional multiple of the display frame rate. For example, for a display frame rate of 60 Hz, the capacitive frame rate may be 90 Hz. However other display frame rates and capacitive frame rates are possible. In yet further embodiments, the capacitive frame rate may be any fraction or integer of the display frame rate. For example, for a display frame rate of 48 Hz, the capacitive frame rate may be 100 Hz. However other display frame rates and capacitive frame rates are possible.

For convenience of explanation, a capacitive image that is taken during a particular display updating state is considered to be of a particular frame type. That is, a particular frame type is associated with a mapping of a particular capacitive sensing sequence with a particular display sequence. Thus, a first capacitive image taken during a first display updating state is considered to be of a first frame type, a second capacitive image taken during a second display updating state is considered to be of a second frame type, a third capacitive image taken during a first display updating state is considered to be of a third frame type, and so on. Where the relationship of display update state and capacitive image acquisition is periodic, capacitive images acquired cycle through the frame types and then repeats. In some embodiments, there may be “n” capacitive images for every display updating state.

FIG. 2B shows a portion of an exemplary pattern of capacitive sensing pixels 205 (also referred to herein as capacitive pixels or sensing pixels) configured to sense in the sensing region 120 associated with a pattern, according to some embodiments. Each capacitive pixel 205 may include one of more of the sensing elements described above. For clarity of illustration and description, FIG. 2B presents the regions of the capacitive pixels 205 in a pattern of simple rectangles and does not show various other components within the capacitive pixels 205. In one embodiment, the capacitive sensing pixels 205 are areas of localized capacitance (capacitive coupling). Capacitive pixels 205 may be formed between an individual sensor electrode and ground in a first mode of operation (i.e., absolute sensing) and between groups of sensor electrodes used as transmitter and receiver electrodes in a second mode of operation (i.e., transcapacitive sensing). The capacitive coupling changes with the proximity and motion of input objects in the sensing region 120 associated with the capacitive pixels 205, and thus may be used as an indicator of the presence of the input object in the sensing region 120 of the input device.

The exemplary pattern comprises an array of capacitive sensing pixels 205_{X,Y} (referred collectively as pixels 205) arranged in X columns and Y rows, wherein X and Y are positive integers, although one of X and Y may be zero. It is contemplated that the pattern of sensing pixels 205 may comprises a plurality of sensing pixels 205 having other configurations, such as polar arrays, repeating patterns, non-repeating patterns, non-uniform arrays a single row or column, or other suitable arrangement. Further, as will be discussed in more detail below, the sensor electrodes in the sensing pixels 205 may be any shape such as circular, rectangular, diamond, star, square, noncovex, convex, nonconcave concave, etc. As shown here, the sensing pixels 205 are coupled to the processing system 110 and utilized to determine the presence (or lack thereof) of an input object in the sensing region 120. In one or more embodiments, each sensor electrode 205 overlaps one or more source lines. Each source line is capacitive coupled to the sensor electrode and when the voltage on source lines is changed, charge may be injected into sensor electrode. This injected charge may cause errors within the measured change in capacitance. In one or more embodiments, the charge injected by each source line coupled to a sensor electrode may be subtracted. Further, in other embodiments, an average amount of charge injected by each source line coupled to a sensor electrode may be subtracted. In yet other embodiments, a reference electrode may be disposed such that it overlaps a common set of source lines with at least one sensor electrode of sensor electrodes 205 and an resulting signal, corresponding to injected charge received from the source lines into the reference electrode may be subtracted from the resulting signal of each corresponding sensor electrode.

In a first mode of operation, at least one sensor electrode within the capacitive sensing pixels 205 may be utilized to detect the presence of an input object via absolute sensing techniques. A sensor module 204 in processing system 110 is configured to drive a sensor electrode in each pixel 205 with a modulated signal and measure a capacitance between the sensor electrode and the input object (e.g., free space or earth ground) based on the modulated signal, which is utilized by the processing system 110 or other processor to determine the position of the input object. In various embodiments, the sensor electrodes are modulated by changing the voltage of the sensor electrodes relative to a system ground of an input device, were the system ground is separately coupled to earth ground.

The various electrodes of capacitive pixels 205 are typically ohmically isolated from the electrodes of other capacitive pixels 205. Additionally, where a pixel 205 includes multiple electrodes, there electrodes may be ohmically isolated from each other. That is, one or more insulators separate the sensor electrodes and prevent them from electrically shorting to each other. Furthermore, in one embodiment, the sensor electrodes in the capacitive pixels 205 may be ohmically insulated from a grid electrode (not shown) that is between the capacitive pixels 205. In one example, the grid electrode may surround one or more of the capacitive pixels 205. The grid electrode may be used as a shield or to carry a guarding signal for use when performing capacitive sensing with the sensor electrodes in the pixels 205. Alternatively or additional, the grid electrode may be used as sensor electrode when performing capacitive sensing. Furthermore, the grid electrode may be co-planar with the sensor electrodes in the capacitive pixels 205 but this is not a requirement. For instance, the grid electrode may be located on a different substrate or on a different side of the same substrate as the sensor electrodes. In various embodiments, the power supply of the display device or an associated power supply of the display device may be modulated relative to system ground such that provided reference voltage(s) are modulated.

In a second mode of operation, sensor electrodes in the capacitive pixels 205 are utilized to detect the presence of an input object via transcapacitance sensing techniques. That is, processing system 110 may drive at least one sensor electrode in a pixel 205 with a transmitter signal and receive resulting signals using one or more of the other sensor electrodes in the pixel 205, where a resulting signal comprising effects corresponding to the transmitter signal. The resulting signal is utilized by the processing system 110 or other processor to determine the position of the input object.

The input device 100 may be configured to operate in any one of the modes described above. The input device 100 may also be configured to switch between any two or more of the modes described above.

In some embodiments, the capacitive pixels 205 are “scanned” to determine these capacitive couplings. That is, in one embodiment, one or more of the sensor electrodes are driven to transmit transmitter signals. Transmitters may be operated such that one transmitter electrode transmits at one time, or multiple transmitter electrodes transmit at the same time. Where multiple transmitter electrodes transmit simultaneously, the multiple transmitter electrodes may transmit the same transmitter signal and effectively produce an effectively larger transmitter electrode. Alternatively, the multiple transmitter electrodes may transmit different transmitter signals. For example, multiple transmitter electrodes may transmit different transmitter signals according to one or more coding schemes that enable their combined effects on the resulting signals of receiver electrodes to be independently determined.

The sensor electrodes configured as receiver sensor electrodes may be operated singly or multiply to acquire resulting signals. The resulting signals may be used to determine measurements of the capacitive couplings at the capacitive pixels 205.

In other embodiments, “scanning” pixels 205 to determine these capacitive coupling includes driving with a modulated signal and measuring the absolute capacitance of one or more of the sensor electrodes. In another embodiment, the sensor electrodes may be operated such that the modulated signal is driven on a sensor electrode in multiple capacitive pixels 205 at the same time. In such embodiments, an absolute capacitive measurement may be obtained from each of the one or more pixels 205 simultaneously. In one embodiment, the input device 100 simultaneously drives a sensor electrode in a plurality of capacitive pixels 205 and measures an absolute capacitive measurement for each of the pixels 205 in the same sensing cycle. In various embodiments, processing system 110 may be configured to selectively drive and receive with a portion of sensor electrodes. For example, the sensor electrodes may be selected based on, but not limited to, an application running on the host processor, a status of the input device, an operating mode of the sensing device and a determined location of an input device. In one embodiment, all of the sensor electrodes 205 may be simultaneously modulated and a grid electrode may be modulated to operate as a guard electrode relative to a system ground while selected sensor electrodes 205 receive and measure a resulting signal to perform capacitive sensing such that a selected region of the sensing region 120 may be sensed at a time. In one embodiment, the selected region is positioned away from gate lines driven for display updating. In one or more embodiments, scanning may occur while the sensor electrodes 205 are not modulated but are received with to obtain a measurement of the interference.

A set of measurements from the capacitive pixels 205 form a capacitive image (also capacitive frame) representative of the capacitive couplings at the pixels 205 as discussed above. Multiple capacitive images may be acquired over multiple time periods, and differences between them used to derive information about input in the sensing region. For example, successive capacitive images acquired over successive periods of time can be used to track the motion(s) of one or more input objects entering, exiting, and within the sensing region.

In some embodiments, one or more of the sensor electrodes in the capacitive pixels 205 include one or more display electrodes used in updating the display of the display screen. In one or more embodiment, the display electrodes comprise one or more segments of a Vcom electrode (common electrodes), a source drive line, gate line, an anode electrode or cathode electrode, or any other display element. These display electrodes may be disposed on an appropriate display screen substrate. For example, the electrodes may be disposed on the a transparent substrate (a glass substrate, TFT glass, or any other transparent material) in some display screens (e.g., In Plane Switching (IPS) or Plane to Line Switching (PLS) Organic Light Emitting Diode (OLED)), on the bottom of the color filter glass of some display screens (e.g., Patterned Vertical Alignment (PVA) or Multi-domain Vertical Alignment (MVA)), over an emissive layer (OLED), etc. In such embodiments, an electrode that is used as both a sensor and a display electrode can also be referred to as a combination electrode, since it performs multiple functions. In one embodiment, all of the sensor electrodes in the capacitive pixels 205 are disposed in a display stack on the display screen substrate. Furthermore, at least one of the sensor electrodes in the display stack may be a combination electrode. However, in other embodiments, only a portion of the sensor electrodes in capacitive pixels 205 are disposed within the display stack while other sensor electrodes are outside of the display stack (e.g., disposed on an opposite side of a color filter glass).

Continuing to refer to FIG. 2B, the processing system 110 coupled to the sensing electrodes includes a sensor module 204 and optionally, a display driver module 208. In one embodiment the sensor module 204 comprises circuitry configured to drive a transmitter signal or a modulated signal onto, and receive resulting signals with, the sensing electrodes during periods in which input sensing is desired. In one embodiment the sensor module 204 includes a transmitter module including circuitry configured to drive a transmitter signal onto the sensing electrodes during periods in which input sensing is desired. The transmitter signal is generally modulated and contains one or more bursts (sensing cycles) over a period of time allocated for input sensing. The transmitter signal may have an amplitude, frequency and voltage which may be changed to obtain more robust location information of the input object in the sensing region. The transmitter may couple to a modulated power supply domain such that the display electrodes are modulated relative to a system ground. Further, in various embodiments, the transmitter may be separate from or included within a source driver. The modulated signal used in absolute capacitive sensing may be the same or different from the transmitter signal used in transcapacitance sensing. The sensor module 204 may be selectively coupled to one or more of the sensor electrodes in the capacitive pixels 205. For example, the sensor module 204 may be coupled to selected portions of the sensor electrodes and operate in either an absolute or transcapacitance sensing mode. In another example, the sensor module 204 may be coupled to different sensor electrodes when operating in the absolute sensing mode than when operating in the transcapacitance sensing mode.

In various embodiments the sensor module 204 may comprise a receiver module that includes circuitry configured to receive a resulting signal with the sensing electrodes comprising effects corresponding to the transmitter signal during periods in which input sensing is desired. In one or more embodiments, the receiver module is configured to drive a modulated signal onto a first sensor electrode in one of the pixels 205 and receive a resulting signal corresponding to the modulated signal to determine changes in absolute capacitance of the sensor electrode. The receiver module may determine a position of the input object in the sensing region 120 or may provide a signal including information indicative of the resulting signal to another module or processor, for example, a determination module or a processor of the electronic device (i.e., a host processor or a timing controller with an integrated sensor processor), for determining the position of the input object in the sensing region 120. In one or more embodiments, the receiver module comprises a plurality of receivers, where each receiver may be an analog front ends (AFEs). Further, at least a portion of the receiver module may be disposed within a source driver.

In one or more embodiments, capacitive sensing (or input sensing) and display updating may occur during at least partially overlapping periods. For example, as a combination electrode is driven for display updating, the combination electrode may also be driven for capacitive sensing. Or overlapping capacitive sensing and display updating may include modulating the reference voltage(s) of the display device and/or modulating at least one display electrode for a display in a time period that at least partially overlaps with when the sensor electrodes are configured for capacitive sensing. In another embodiment, capacitive sensing and display updating may occur during non-overlapping periods, also referred to as non-display update periods. In various embodiments, the non-display update periods may occur between display line update periods for two display lines of a display frame and may be at least as long in time as the display update period. In such embodiment, the non-display update period may be referred to as a long horizontal blanking period, long h-blanking period or a distributed blanking period. In other embodiments, the non-display update period may comprise horizontal blanking periods and vertical blanking periods. Processing system 110 may be configured to drive sensor electrodes for capacitive sensing during any one or more of or any combination of the different non-display update times. Non-display update periods may be used for sensing other than touch or capacitive sensing (e.g., interference measurements, active modulated inputs). In various embodiments, non-display update periods may be used to maintain constant display frame rates while the line rate is changing for input sensing, such that neither display updating or input sensing are significantly affected (i.e., maintaining a constant input sensing report rate, display refresh rate, and/or the like).

The display driver module 208 includes circuitry confirmed to provide display image update information to the display of the display device during non-sensing (e.g., display updating) periods. The display driver module 208 may be included with or separate from the sensor module 204. In one embodiment, the processing system comprises a first integrated controller comprising the display driver module 208 and at least a portion of the sensor module 204 (i.e., transmitter module and/or receiver module). In another embodiment, the processing system comprises a first integrated controller comprising the display driver 208 and a second integrated controller comprising the sensor module 204. In yet another embodiment, the processing system comprises a first integrated controller comprising a display driver module 208 and one of a transmitter module or a receiver module and a second integrated controller comprising the other one of the transmitter module and receiver module.

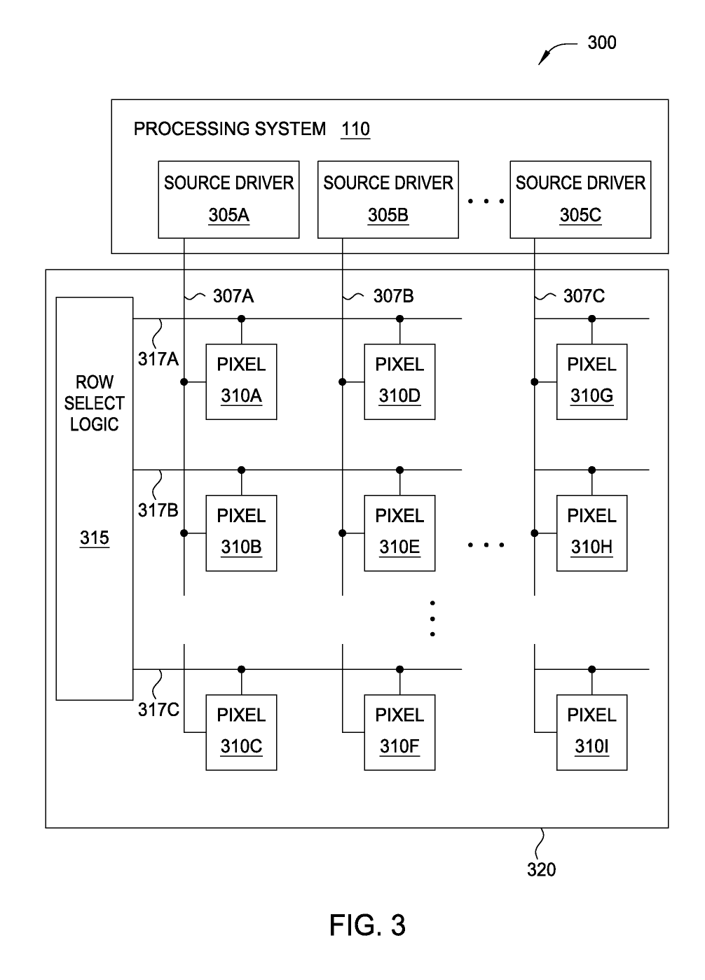

FIG. 3 is a schematic block diagram of a display device 300, according to one embodiment described herein. Specifically, the display device 300 of FIG. 3 may be integrated with an input device and includes processing system 110 and display screen 320. Processing system 110 includes one or more source drivers 305 that are each associated with one or more source lines 307 (also referred to as column lines) in the display screen 320. In one embodiment, processing system 110 and display screen 320 are separate components. For example, the processing system 110 may be an ASIC that is communicatively coupled to the display screen 320 via one or more transmission lines. However, in one embodiment, processing system 110 may be integrated into display screen 320 (e.g., mounted on a common substrate) to form a single component. In various embodiments, processing system 110 may further include a timing controller (Tcon) and/or a power management integrated circuit(s) (PMIC). The timing controller may be disposed within a first integrated circuit and a source driver is disposed within a second integrated circuit. Further, in various embodiments, the timing controller is configured to receive at least one of processed, partially processed or unprocessed data from the source driver comprising at least a portion of a transmitter or receiver module. The timing control may be configured to process the data to determine positional information, gestural information and/or interference information. The timing controller may be configured to communicate control signals to source drivers 305 and row select logic 315, the control signals based on display data from a host processor. The timing controller may report sensor data to the host processor, the sensor data comprising positional information. In one or more embodiments the timing controller may be configured to signal the host processor to enter or exit a lower power mode based on the positional information. In various embodiments, the timing controller may be configured to update the display while the host is in a low power state. The timing controller may control one of capacitive sensing timing and display line rate timing. Further the timing controller may be configured to control capacitive sensing functions, such as, operating sensor electrodes for transcapacitive sensing, operating sensor electrodes for absolute capacitive sensing, and/or selecting sensor electrodes to operate for transcapacitive sensing and absolute capacitive sensing and when to operate the sensor electrodes for transcapacitive sensing and absolute capacitive sensing. Further, the timing controller may be configured to initiate a non-display update time. In one or more embodiments, the power management integrated circuit provides power signals and regulated voltages to the source drivers and row select logic (gate select logic). The power management integrated circuit may generate common voltages and gamma voltages.

The source drivers 305 may receive an input voltage signal which is amplified and transmitted on the source lines 307. Display screen 320 includes one or more pixels 310 coupled to row select logic 315 via respective gate lines 317 (also referred to as “rows” or “lines”). The pixels 310 (in contrast to the capacitive pixels discussed above) may be used to display an image on the display screen 320. The pixels 310 may be used in a light emitting diode (LED), organic LED (OLED), cathode ray tube (CRT), liquid crystal display (LCD), plasma, electroluminescence (EL), or other display technology to display the image.

To update a particular display pixel 310, the row select logic 315 activates one of the gate lines 317. In one embodiment, each pixel 310 may contain a switching element that permits the voltage of the source line 307 to change the color emitted by the pixel 310. For example, to update pixel 310D, row select logic 315 using gate line 317A to control the switching element such that the voltage generated by source driver 305B changes the voltage associated with pixel 310D. By coordinating the row select logic 315 with the voltages transmitted by the source drivers 305, the processing system 110 and display screen 320 may set the pixels 310 to respective voltages.

In one embodiment, as discussed above, processing system 110 and display screen 320 may include touch-sensing circuitry and logic for supporting user input. For the sake of clarity, the embodiments provided below do not discuss touch sensing functions. However, these functions are explicitly contemplated. That is, the display circuitry and functions discussed herein may be combined with additional circuitry for enabling user input via touch-sensing.

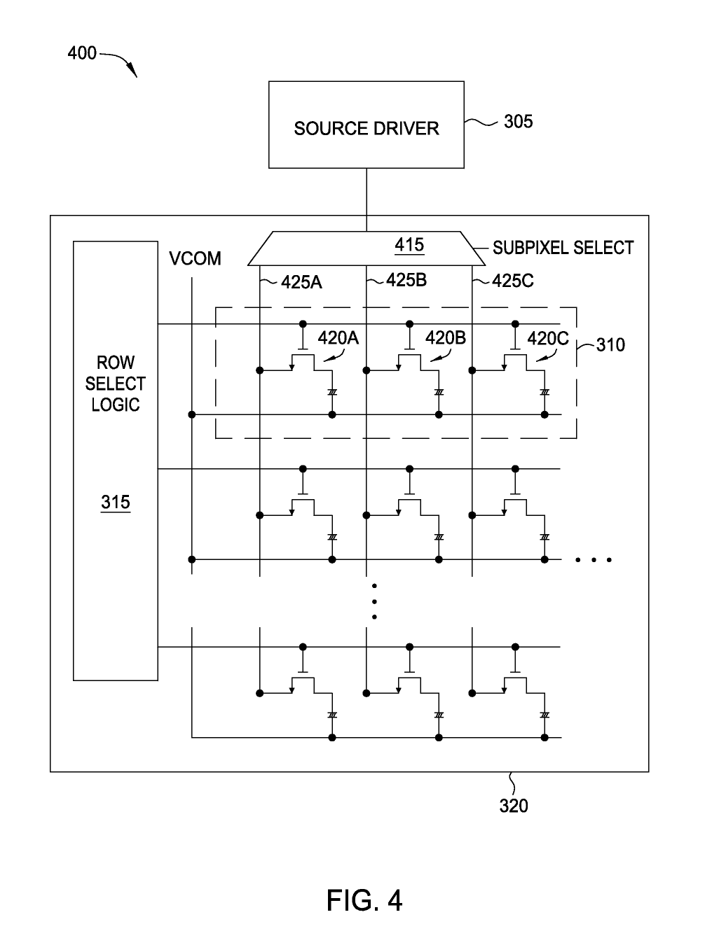

FIG. 4 illustrates a system 400 for updating a source line 425 in a display device, according to one embodiment described herein. Specifically, system 400 includes source driver 305 (i.e., one of the source drivers shown in FIG. 3) coupled to plurality of source lines 425 in display screen 320. As shown here, each source driver 305 is coupled to three source lines 425 which are each associated with a respective sub-pixel 420. In this embodiment, the pixels 310 are divided into three sub-pixels 420 that are combined to provide the color associated with the pixel 310—e.g., sub-pixel 420A is the red sub-pixel, sub-pixel 420B is the green sub-pixel, and sub-pixel 420C is the blue sub-pixel. Accordingly, when setting the voltage, and thus, the color of a pixel 310, source driver 305 may use three separate drive phases, one for each sub-pixel 420. To select between the different sub-pixel source lines 425, display screen 320 include multiplexer (mux) 415. Based on a sub-pixel select signal, mux 415 permits the voltage transmitted by source driver 305 to reach only one of the three source lines 425 at any given time. Thus, each source driver 305 may use only one wire to transmit three unique voltages to each sub-pixel source line 425. Moreover, each pixel is shown including a capacitor representing a liquid crystal pixel, but as discussed above, the display screen is not limited to this type. In one or more embodiments, the row select logic 315 may be configured to select a display line to update using “pipelining”. In such embodiments, multiple display lines are driven at one time in an overlapping manner. As a display line reaches the “turn-on” voltage, the display line is updated.

Although FIG. 4 illustrates one source driver selectively coupled to three source lines, the present disclosure is not limited to such. Instead, the embodiments described herein may be used in display devices that use a source driver to driver any number of source lines. Moreover, FIG. 4 illustrates using one select signal to couple the source lines 425 to the source driver 305 but in other embodiments it may be preferred to use three different control signals to permit access to the sub-pixels 420. As will be discussed in greater detail below, the three different control signals may be used to interconnect the source lines 425 to each other (e.g., source lines 425A-C are interconnected to discharge the built up charge. Further, while FIG. 4 illustrates that the Vcom electrode is perpendicular to source lines 425, in various embodiments, the Vcom electrode may be segmented where each segment may be disposed substantially parallel to the source lines 425. Further, a single segment of a Vcom electrode may correspond to each pixel 310 or a different segment may correspond to each sub-pixel 420A, 420B and 420C. The Vcom electrode segments may be coupled to and selectively driven using multiplexer 415; however, in various embodiments a second multiplexer may be used. In one or more embodiments at least a portion of sensor module 204 (i.e., a portion of a receiver module, transmitter module and/or the like) may be disposed within multiplexer 415. In various embodiments, the multiplexer 415 may be disposed on a substrate of the display device as a discrete component or as part of the source driver 305.

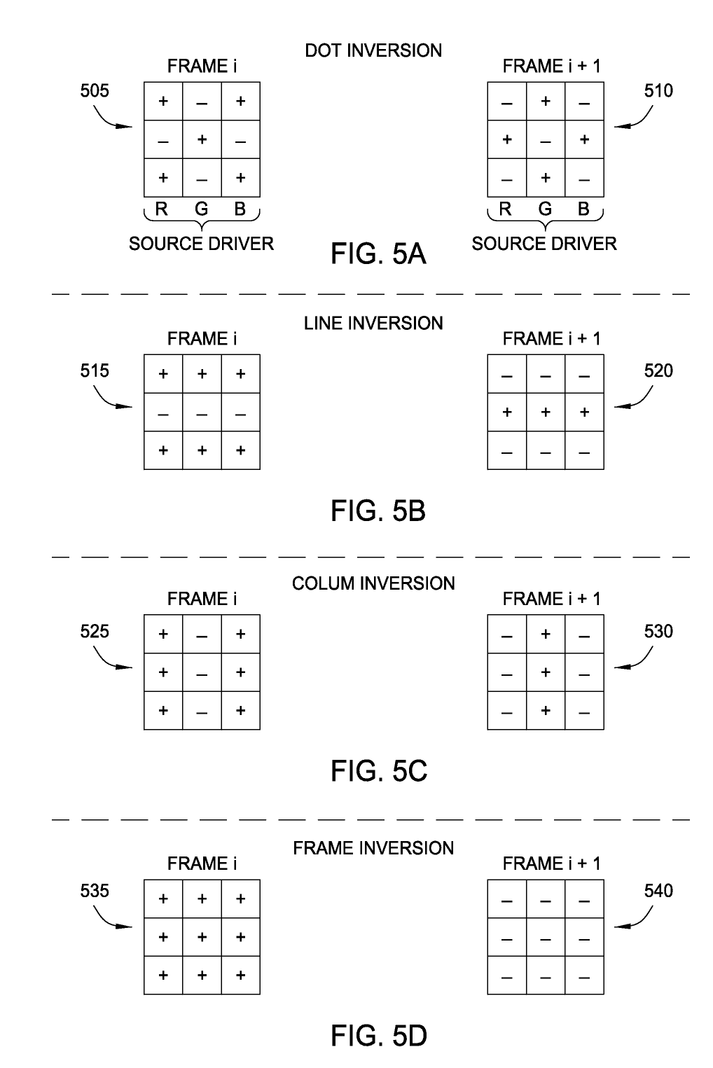

FIGS. 5A-5D illustrate inversion schemes for a display device, according to embodiments described herein. Specifically, FIGS. 5A-5D illustrate the polarity assigned to different pixels (or sub-pixels) in the display screen. In one embodiment, the display screen may use an inversion scheme to apply a net voltage of substantially zero across two display frames (assuming the data/color stays the same).

Chart 505 of FIG. 5A illustrates the polarity of the voltage across each pixel or sub-pixel represented by the individual boxes. For clarity, the term “pixel” will be used generally in FIGS. 5A-5D to represent both a pixel that may include multiple sub-pixels and an individual sub-pixel within a pixel (e.g., the red, blue, or green sub-pixels). For example, the pixels in chart 505 can illustrate that the first column includes red sub-pixels, the second column includes green sub-pixels, and the third column includes blue sub-pixels which are selectively coupled to the same source driver. Furthermore, for all the inversion schemes shown in FIGS. 5A-5D, it is equally possible that each box represents a single pixel and its corresponding sub-pixels (if any). In this scenario, the top, leftmost box in chart 505 has positive voltage polarity which means all the sub-pixels of this pixel would have the same positive polarity. On the other hand, boxes with negative polarity would mean all the corresponding sub-pixels have negative polarity voltages. This is referred to as pixel inversion where the groups of sub-pixels making up the pixel are inverted together.

In one embodiment, the voltage set on the pixels ranges between −5 to 5V. Because the same color is produced regardless whether the pixel is set to a positive voltage or a negative voltage (e.g., the color is the same if the pixel is set to −3V or 3V), the display screen may change the polarity of the voltage used without affecting the displayed color. In many embodiments, the pixel intensity (i.e., grey level) is determined by the RMS amplitude of the voltage modulation applied to the source line and/or Vcom electrode. Charts 505 and 510 illustrate dot or pixel inversion where the polarity switches for every neighboring pixel in a row. However, when a subsequent display frame is received as shown in Chart 510, the polarity for each pixel is swapped as the display screen is updated. By swapping the polarities, the display screen may improve the image quality, display lifetime, and/or reduce any noise that may affect other systems in an input device such as capacitive sensing.

Charts 515 and 520 of FIG. 5B illustrate row or line inversion. Here, the pixels in a row have a voltage polarity that is opposite than a voltage polarity of the pixels in a neighboring or adjacent row. Thus, as the input device scans through the rows, the source drivers drive voltages onto the pixels with opposite polarity than the previous line (or row) update. After receiving a subsequent frame as shown in chart 520, the polarity of each pixel in the display screen is switched. As such, the pattern of the pixels in adjacent rows having pixels with opposite voltage polarities is maintained.

Charts 525 and 530 of FIG. 5C illustrate column inversion. Here, the pixels in a column have a voltage polarity that is opposite than a voltage polarity of the pixels in a neighboring or adjacent column. In this case, as the display device scans through the rows to update the pixels for a frame, the source drivers may not need to change polarity between subsequent line updates. However, if the boxes in charts 525 and 530 illustrate three columns of sub-pixels that are selectively coupled to the same source driver, then the source driver may change polarity as it updates the three sub-pixels in the same row. Regardless, the voltage polarity of the pixels in the same columns does not change.

Chart 530 illustrates the polarity of the pixels after receiving a subsequent display frame. Like above, the voltage polarity of each pixel is reversed thereby maintaining the pattern where every pixel in a column has the opposite voltage polarity from the pixels in the adjacent column or columns.

Charts 535 and 540 of FIG. 5D illustrate frame inversion. Here, the voltage polarity of all the pixels in the display screen is the same for any given frame. That is, the voltages of each pixel may be different but nonetheless have the same polarity (e.g., the voltages are all positive relative to Vcom). Chart 540 illustrates the subsequent display frame where the voltage polarity of each pixel is reversed. Like in column inversion, frame inversion does not require the source drivers to change polarity as they scan through the rows.

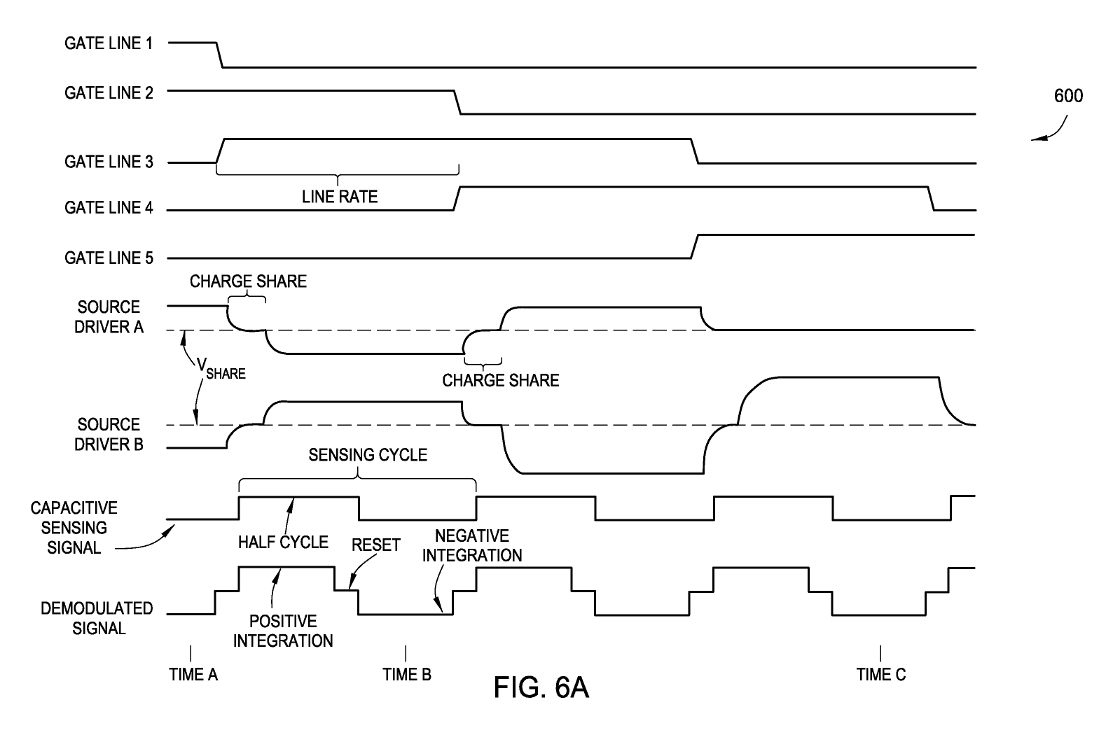

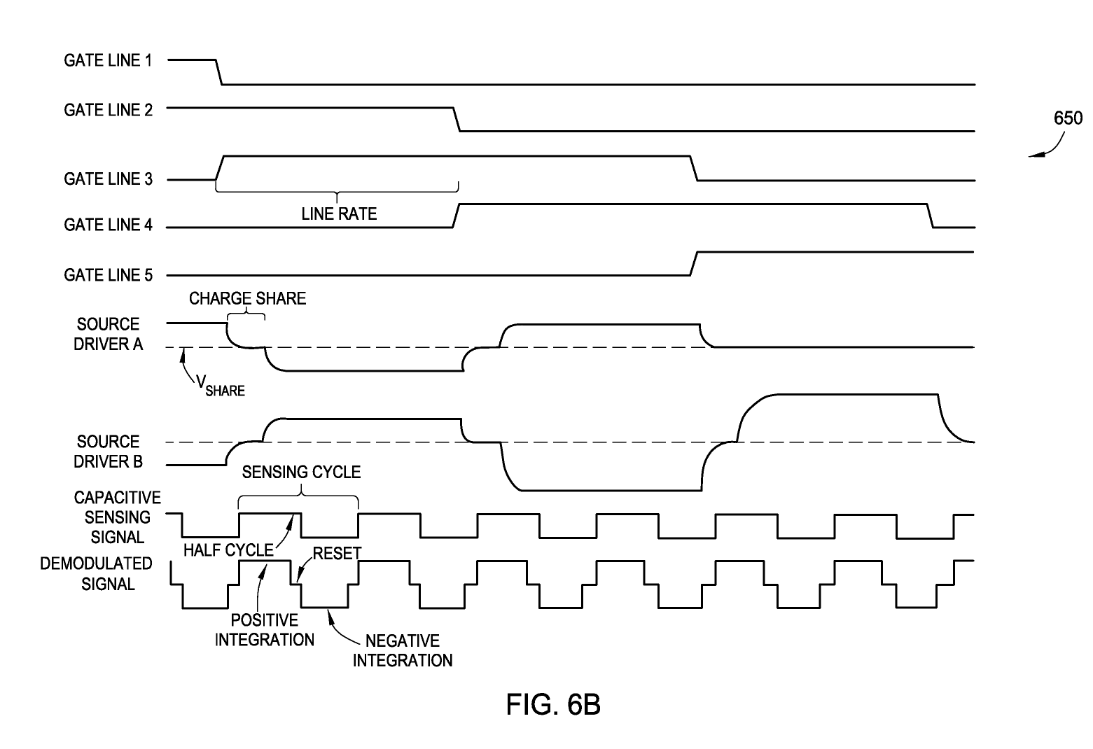

FIGS. 6A-6B illustrate timing charts 600 and 650 for synchronizing capacitive sensing with display updating, according to embodiments described herein. Specifically, FIG. 6A includes a timing chart 600 that illustrates the signals driven on Gate Lines 1-5, Source Drivers A and B, a capacitive sensing signal on a sensor electrode, and a demodulated signal based on the capacitive sensing signal. The capacitive sensing signal may be a signal used to perform absolute capacitive sensing and/or transcapacitive sensing. In one embodiment, the Gate Lines 1-5 are arranged sequentially in a display screen such that Gate Line 1 permits Source Drivers A and B to change the voltage on pixels in a first row, Gate Line 2 permits Source Drivers A and B to change the voltage on pixels in a second row adjacent to the first row, Gate Line 3 permits Source Drivers A and B to change the voltage on pixels in a third row adjacent to the second row, and so forth. It is further assumed in FIGS. 6A and 6B that the Source Drivers A and B set the voltage on pixels (or sub-pixels) that are in adjacent columns in the display screen. In one or more embodiments, there may be at least one sensing cycle per line update. The line rate may be equal to the inverse of the line period. For example, for a line period of 100 kHz, the line rate is 10 microseconds.

In FIGS. 6A-6B, the Gate Lines 1-5 are shown as pipelined gate lines. In some display screens, the transistor coupled to the gate lines requires more time to turn on than to turn off. Stated differently, it takes longer for the transistor to electrically connect the output of the source driver to the pixel so that the source drive can set the voltage across the pixel than to electrical disconnect the source driver from the pixel. As a result, the gates may be pipelined so that the time period one gate line is activated at least partially overlaps with the time period another gate line is activated. By activating the gates lines earlier, this provides time for the signal to settle so that when that corresponding row is being updated, the correct voltage is set across the pixel. However, by activating the gate lines earlier, this may result in the Source Drivers A and B changing the voltage across the pixels on both rows. For example, at Time A, both Gate Lines 1 and 2 are active, and thus, the Source Drivers A and B may affect the voltages on the corresponding pixels on both rows although the voltage being driven by the source drivers is only intended for the row corresponding to Gate Line 1. However, at Time B, Gate Line 1 is turned off while Gate Line 2 is still active and the outputs of the Source Drivers A and B have changed to the desired voltage for the row corresponding to Gate Line 2. Thus, any undesired change in voltage caused when Gate Lines 1 and 2 overlapped at Time A is corrected at Time B when Gate Line 1 is deactivated and the correct voltage is outputted by Source Drivers A and B. Although gate pipelining is shown in FIGS. 6A and 6B, the embodiments described herein may also be applied to an input device where the gate lines are non-overlapping. In one or more embodiments, capacitive sensing occurs during a non-display update period. With reference to FIG. 6A, the non-display update period may occur between the time when gate lines 3 and 4 are selected. As such, display updating is paused after gate line 3 is selected and before gate line 4 is selected. In one embodiment, after the non-display update period, gate line 3 may be selected and driven before selecting and driving gate line 4. In another embodiment, after the non-display update period, the display is delayed for an additional period of time to allow gate line 4 to reach the appropriate “turn-on” voltage.

Generally, timing chart 600 illustrates updating pixels in the same two columns during four consecutive line updates. The voltages on the pixels may be the same or different depending on the data included within a received data frame. For instance, at Time A, the voltages applied by Source Driver A and B are equal in amplitude but opposite in polarity. As mentioned above, the polarity of the voltages does not affect the color of the pixel, and thus, the voltages across the two pixels updated at Time A have the same color. Furthermore, timing charts 600 and 650 illustrate using one of the inversion schemes discussed above. Specifically, the charts 600 and 650 illustrate an inversion scheme where the Source Drivers A and B output different voltage polarities each time they update subsequent rows which is a feature of dot inversion, pixel inversion, and line inversion. In addition, timing charts 600 and 650 illustrate that the voltage polarity between pixels in the same row and adjacent columns have opposite polarities as is done is dot inversion and pixel inversion but this is not a requirement. For instance, if a line inversion scheme is used instead of dot or pixel inversion, the output polarities of Source Drivers A and B may be the same during a line or row update (i.e., on the same side of V_{SHARE}) and both switch to the opposite polarity during a subsequent line update. Furthermore, although timing charts 600 and 650 do not show using the other inversion schemes where the source drivers do not change polarity on each subsequent line update such as in column inversion or frame inversion, the ability to synchronize the phase and frequency of the capacitive sensing signals and the display signals to achieve simultaneous capacitive sensing and display updating as discussed herein also applies to these inversion schemes.

When switching output polarities of Source Drivers A and B between line updates, in one embodiment, the input device uses charge share methods between driving source drivers for line updates to conserve power. For instance, referring to FIG. 5A which illustrates a dot inversion scheme, there each row has sub-pixels charged to opposite polarities. Assuming an even number of pixels in a row, then the input device has an equal number of voltages with a positive polarity and a negative polarity on each row. Moreover, the source drivers must drive voltages with opposite polarities during each subsequent line update. That is, the source drivers must drive a pixel from a positive polarity to a negative polarity or vice versa during each of the line updates. In addition, the source driver amplifiers may need to deal with the latent charge stored on the source line from the previous line update. To conserve power, the input device may use the charge share time periods illustrated in chart 600. During this time period, the source lines coupled to the Source Drivers A and B may be connected to a common node thereby permitting each of the sources lines to share charge. Depending on the actual amplitudes of the voltages on each pixel/source line, the voltages on the source lines go to V_{SHARE} which may be approximately equal to system ground (e.g., Vcom). V_{SHARE} may be different than the system ground because the amplitudes of the pixel voltages depend on the color the data frame assigns to each pixel. For example, at Time A, Source Drivers A and B output voltages with the same amplitude but different polarity onto their respective pixels, but at Time C, Source Driver A outputs a low amplitude voltage (e.g., a black pixel) while Source Driver B outputs the maximum voltage (e.g., a white pixel). Thus, because the pixels colors on a row may be different, there may be more total positive charge than total negative charge in the source lines or vice versa. Nonetheless, this variation (for typical uniform or slowly charging brightness gradients) is usually slight and the negatively and positively charged source lines equalize to V_{SHARE} which is typically near Vcom. Alternatively or additionally, the source lines and the V_{SHARE} voltage may be connected to the Vcom voltage for a portion of time (e.g., at the beginning or end of a capacitive measurement). After a charge share event, the source lines are returned to Vcom without the input device expending power to do so. Furthermore, in one embodiment, V_{SHARE} may be offset from Vcom by an amount to compensate for charge subtraction from gate capacitive coupling.

Once the charge share is complete, the input device may then power the Source Drivers A and B so they then drive the desired voltages onto the pixels in the activated row. Thus, the Source Drivers A and B only have to drive the source lines from V_{SHARE} to the desired voltages rather than from voltages that have an opposite polarity. However, in other embodiments, charge sharing may not be used. For instance, in line inversion where the source lines may be at the same polarity during each line update, charge sharing between line updates may not be used.

In addition to updating the pixels in the display, timing charts 600 and 650 illustrate driving a capacitive sensing signal onto a sensor electrode in the input device. For example, the capacitive sensing signal may be a modulated signal used to perform absolute capacitive sensing or a transmitter signal used to perform transcapacitive sensing as discussed above. Although a square wave is shown, any waveform suitable for capacitive sensing may be used.

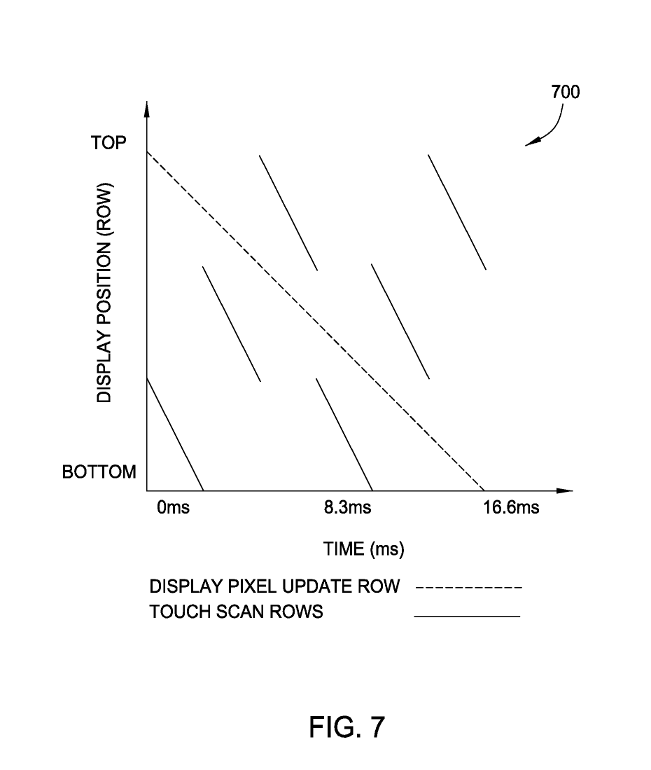

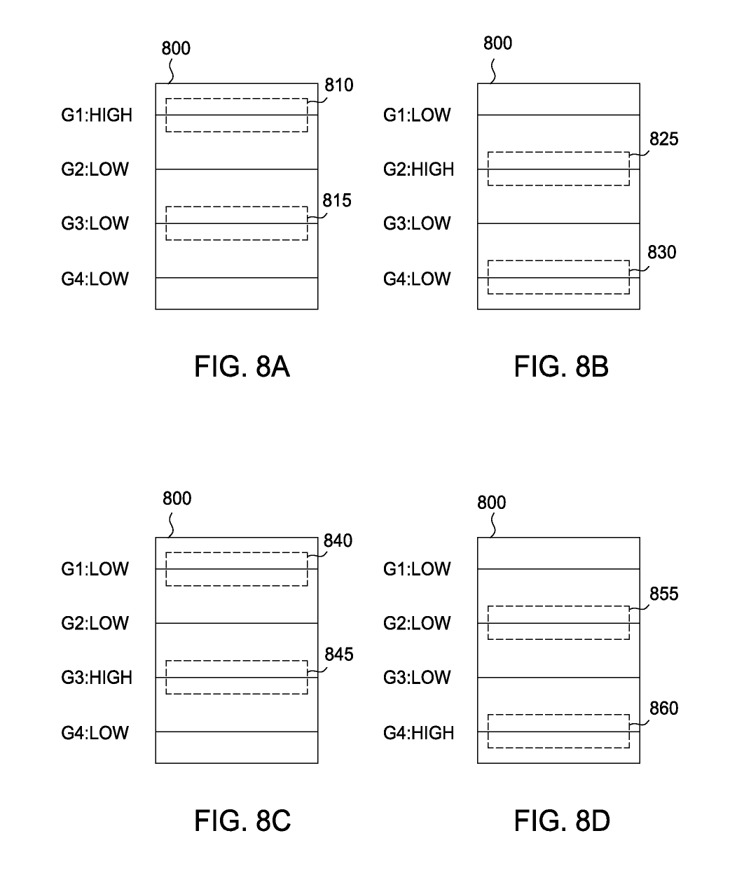

When performing capacitive sensing and display updating simultaneously, the display signals may interfere or insert noise into the capacitive sensing signals and vice versa. For example, the display electrodes (e.g., gate lines, source lines, Vcom electrodes) may be in close proximity to the capacitive sensing electrodes (e.g., sensor electrodes) in the input device such that these electrodes are capacitively coupled. For example, the signals driven on Gate Lines 1-5 and the outputs of Source Drivers A and B and may insert noise into the capacitive sensing signal and vice versa. To reduce noise between the gate lines and sensor electrodes, in some embodiments, display updating and capacitive sensing may be spatially separated in the display screen. That is, while the input device is updating the pixels in a first portion of the display, the device may simultaneously be performing capacitive sensing in a second portion of the display where the sensor electrodes in the second portion are substantially unaffected by a display signal driven on a display electrode in the first portion. This spatial separation is discussed in more detail in the FIGS. 7 and 8A-8D.

However, the input device may be unable to avoid the noise caused by the source drivers by using spatial separation because the source drivers (and source lines) are used simultaneously when updating a row. That is, each of the source drivers may constantly drive modulated voltages onto the source lines which extend throughout the display screen. In contrast, the input device may activate (e.g., increase the voltage) only one or a small number of gate lines at a time when performing a line update while the other gate lines are unused (e.g., remain at a low voltage).

To mitigate noise between the source lines and sensor electrodes, the input device synchronizes the phase and frequency of the capacitive sensing signal to the display signals. Timing chart 600 illustrates the line rate used when performing display updating which represents the time used by the input device to update a single row in the display (i.e., a line update). During the time period defined by the line rate, the input device performs the charge share and the source drivers drive the desired voltages across the pixels. At the end of this time period, a gate line is deactivated and the input device begins to update the pixels on the subsequent row. Turning to the capacitive sensing signal, it includes a plurality of sensing cycles each divided into two half cycles (e.g., a HIGH portion and a LOW portion). As shown here, the rate of the half cycles is approximately twice as fast as the line rate. Stated differently, during each line update time, the capacitive sensing signal performs one full sensing cycle. However, in other embodiments, the time period of the half cycles is any multiple of the time period of the line rate—e.g., the time period of the half cycles can be two times, three times, four times, five times, etc., shorter than the time period of the line update. In another embodiment, the time period of the line update may be greater than the time period of the half cycles. For example, the line rate may be two, four, eight, or sixteen times faster than the half cycle rate. In some input devices, however, it may be preferred to use half cycle time periods that are shorter than the line update (e.g., a half cycle rate that is faster than the line rate) since this allows the input device to perform greater numbers of sensing cycles and gather additional samples which may improve capacitive sensing. Also, the number of half-cycles per line may be even and/or the number of lines over which a capacitive measurement is filtered is an even number. Regardless whether the line rate is faster or slower than the half cycle rate, the frequency associated with display updating can be synchronized with the frequency of the capacitive sensing signal. Thus, if the input device changes the frequency of display updating, thereby changing the line rate, the device may also update the frequency of the capacitive sensing signal so that the relationship between the line rate and the time period of the half cycles is maintained.

In addition to synchronizing the frequencies of the display and capacitive sensing signals, these signals are phase aligned. As shown here, the transition from the LOW half cycle to the HIGH half cycle occurs during charge share events when the Source Drivers A and B switch between updating subsequent rows in the display. Thus, when Source Drivers A and B perform charge sharing, a capacitive sensing module (e.g., AFE) coupled to the sensor electrode is performing a reset of the receiver (i.e., AFE input voltage) which is shown by the demodulated signal. Specifically, the demodulated signal is divided into three different periods: a positive integration period, a reset period, and negative integration period. As shown, the capacitive sensing module performs the positive integration to integrate the charge detected during a portion of the HIGH half cycle and the negative integration to integrate the charge detected during a portion of the LOW half cycle. The reset period is used to reset an analog circuit in the capacitive sensing module between the integration periods. The capacitive sensing module may process and filter a plurality of different samples (e.g., an even number of cycles and/or a number of cycles over an even number of lines) taken during the integration period to detect a change in capacitance (i.e., to perform a measurement of a change in capacitance) that indicates the proximity of an input object to the input device. To prevent or mitigate noise from the source lines from affecting the filtered samples, the reset period of the demodulated signal may always occur during the gate transition and/or the charge share event which are common sources of noise. Advantageously, by aligning the reset period with the charge share events, the source lines are stationary (i.e., not actively being driven to a different voltage) and the gate lines are not changing.

However, the fact that the capacitive sensing signal is phase aligned with the output of the source drivers such that the charge event falls within the reset period is not what is most important. Instead, the fact that the charge share event (or any periodic noise event) consistently falls within the same period of the demodulation signal is what mitigates the effects of the noise event. For example, it is equally permissible to phase align the signals such that the charge event falls within either the positive or negative integration periods. The point being that the input device ensures that any periodic noise event occurring from the display signals (such as a charge share event or gate line transitions) affects the capacitive sensing samples in the same way. Thus, if a substantially symmetric and opposite charge share event always occurs within the positive integration period, when the samples are processed and filtered, the charge share events do not indicate any change of capacitance since the filtered measurements are affected equally. In contrast, if the charge share event happens during the reset period in a first sensing cycle but during the negative integration period in a second sensing cycle, the charge caused by the change in voltage coupled to the sensor electrode in the first sensing cycle is lost which may eventually cause the sensing module to erroneously detect a change in capacitance if the problem persists—i.e., the signals remain unsynchronized or are not balanced on a subsequent sensing cycle within a common measurement.

In one or more embodiments, an even number of lines are driven per measurement and/or an even number of sensing cycles is driven per measurement. In various embodiments, the above methods may be used to maintain a constant display line rate during a capacitive measurement period using a display buffer (e.g., for a non-display update period).

Moreover, phase aligning the display and capacitive signals as shown in timing chart 600 also mitigates for the noise generated by the transitions of the gate lines on the sensor electrodes used for capacitive sensing. As shown, the gate transitions (e.g., from OFF to ON or ON to OFF) occur during the reset period when the charge introduced on the sensor electrode by this noise event is ignored thereby mitigating any effect of the gate line transitions on capacitive sensing. In other embodiments, these noise events can be cancelled out if the transitions happen in the same integration period as discussed above—e.g., the transitions always occurs in the positive integration period. In various embodiments, even where the gate transitions take longer than the reset time of the receiver, the difference in total injected charge is reduced and may be substantially constant. Because the periodic transitions affect the positive integration periods in the same manner, when samples are combined and filtered, the charge caused by the noise event on the sensor electrode does not indicate a change in capacitance.

In another embodiment, instead of synchronizing phase and frequency such that the periodic noise event occurs in the same period in each sensing cycle, in one sensing cycle the noise event occurs in the positive integration period but in a subsequent sensing cycle the noise event occurs in the negative integration period. If this substantially symmetric pattern continues, then whatever charge introduced by the noise event in the positive and negative integrations is compensated for when the samples from both integration periods are averaged by a filter to yield a measurement.

In another embodiment, the display and capacitive signals may be synchronized so that the up and down transitions of a noise event occur in the same half cycle. For example, if the time period of the half cycle is two times greater than the time period of the line update, the capacitive sensing signal can be phase aligned such that two consecutive charge share events both occur during one polarity of the integration periods. Furthermore, in another embodiment, display and capacitive sensing signals may be synchronized and phase aligned such that the up transitions of a noise event (e.g., from a low voltage to a higher voltage) may all occur in the positive integration period and the down transitions (e.g., from a high voltage to a lower voltage) all occur in the negative integration period. Like above, once the samples are filtered, the contribution of charge substantially balances and the noise event does not indicate a change of capacitance, and thus, is not interpreted as a proximate input object.

Furthermore, in electrode layouts where the sensor electrodes used in capacitive sensing extend over an even number of source lines, there is an additional cancellation of the noise events generated on the source lines when the polarity of each source line is opposite the polarity of the adjacent source line which occurs during dot, pixel, and line inversions. Even if two adjacent source lines have different voltage amplitudes (i.e., the pixels are set to different colors), because the polarities are opposite, a noise event in one of the adjacent source lines will be in the opposite direction (e.g., from a low voltage to a high voltage or vice versa) than the same noise event in the other source line. Because the capacitive sensing signal is synchronized with the display line rate, the noise event will affect the samples of the capacitive sensing signal in the same manner, and thus, not indicate a change in capacitance.

FIG. 6B is similar to FIG. 6A except the time period of the half cycles in the capacitive sensing signal is four times shorter than the time period of a line update. Stated different, the half cycle rate is four times faster than the line rate. In timing chart 650, for each line update, the input device performs two sensing cycles. In addition to the frequency of the capacitive sensing signal being synchronized to the line rate of the display signals, the capacitive sensing signal is phase aligned with the source signals such that the reset periods at least partially overlap with the charge share events. Unlike in timing chart 600, however, the reset period does not overlap with the gate line transitions. Nonetheless, because the opposing gate line transitions occur in the negative integration period (even though the same local transitions may not occur in subsequent negative integration periods except in a succeeding display frame), as long as enough of the samples taken during the negative integration periods are combined and filtered (e.g., more than four sensing cycle samples), the charge introduced onto the sensor electrodes during the gate line transitions will not be mistaken as a change in capacitance by the processing system. In some embodiments, either the gate line transitions or source driver transitions may be staggered in time while still allowing substantial cancelation of injected charge during a filtered capacitive measurement by phase and frequency selection.

As described above, the frequency synchronization and the phase alignment between the capacitive sensing signal and the display signals (e.g., gate lines and source lines) shown in timing chart 650 is only one example for compensating for the periodic noise events introduced by the display electrodes onto sensor electrodes. The frequency of the capacitive sensing signal may either by increased or decreased in the intervals described above and/or the sensing signal may be phase aligned differently. Moreover, the sensor electrode used for providing the capacitive sensing signal may include one or more display electrodes—i.e., the sensor electrode is a combination electrode that is used for both capacitive sensing and display updating. However, in one embodiment, when a combination electrode is being used as a sensor electrode for transmitting or receiving capacitive signals, the combination electrode is not simultaneously being directly used as a display electrode (e.g., a source line, gate line, or Vcom) for a pixel or display line being updated.

FIG. 7 is a chart 700 that illustrates spatially separating capacitive sensing from active gate lines, according to one embodiment described herein. In general, chart 700 illustrates one example of simultaneously performing capacitive and display updating in an input device. In one embodiment, the capacitive sensing signal discussed in FIGS. 6A-6B is driven onto at least one sensor electrode in the input device while display signals are driven onto display electrodes in the device (e.g., gate lines, source lines, Vcom electrodes, and the like).

The x-axis of chart 700 indicates time while the y-axis indicates the row of a display screen. Moreover, chart 700 illustrates updating the pixels in lines sequentially in a display based on a single display frame. Thus, in this embodiment, it takes approximately 16.6 ms for the input device to update each pixel in the display based on a received frame. As shown, the input device rasters through the rows sequentially (e.g., from the topmost row to the bottommost row). To update the row, as discussed in FIG. 3 above, the input device activates a gate line which permits the source drivers to drive the desired voltage onto each of the pixels in the corresponding row. The gate driver and source drivers are synchronized so that the correct voltage is driven onto the respective pixels during each line (or row) update.

In one embodiment, the gate lines may be capacitively coupled to one or more of the sensor electrodes used to perform capacitive sensing. For example, the gate lines may be disposed proximate to one of more of the sensor electrodes in an integrated display screen that is used for both displaying an image and providing a capacitive sensing region. Alternatively, the gates lines themselves may be part of combination electrodes that are used for both display updating and capacitive sensing. In either case, driving display signals onto the gate lines may adversely affect the capacitive sensing signal driven onto the sensor electrodes. For example, the gate line transitions when a gate line is activated or deactivated may inject charge onto a capacitively coupled sensor electrode which may cause the capacitive sensing module to output an erroneous result.

To prevent the display signals on the gate line from affecting capacitive sensing, chart 700 illustrates performing capacitive sensing on rows that are spatially separated from the currently active gate lines. For example, at 0 ms or soon thereafter, the row at the top of the display screen is active but the capacitive sensing signal is driven on a row closer to the bottom of the display screen. In one embodiment, the sensor electrodes are parallel to the gate lines in the display device (or could be the gate lines themselves). While the gate lines are used for display updating, sensor electrodes physically separated from the currently active gate lines are driven with the capacitive sensing signal. For example, between a negative off level and a more negative voltage; however, other voltage transitions are also possible. As the input device sequentially progresses through the gate lines to update the display, the input device simultaneously performs capacitive sensing using sensor electrodes in the same rows but at different times. In one embodiment, the input device will perform capacitive sensing only on a sensor electrode (or electrodes) that does not overlap the currently active gate line, or more generally, does not overlap the pixels associated with the active gate line. For example, the input device may ensure that capacitive sensing is done on sensor electrodes that are some predefined distance from the active row—e.g., capacitive sensing is performed only on sensor electrodes that are at least five rows away from the currently active row.

In one embodiment, the gate lines are arranged as horizontal lines that extend from the left to right to establish the rows while the source lines are arranged as vertical columns extending from the bottom to the top of the screen. The sensor electrodes, however, may take on any of the various shapes and patterns of any of the examples provided in FIGS. 2A and 2B. Moreover, the sensor electrodes may be combination electrodes that include one or more display electrodes.

Chart 700 illustrates that capacitive sensing may be performed on each row twice during each display frame update, but this is only one example. Moreover, although not shown, capacitive sensing may also occur when the input device is not currently updating the display. For example, some display devices includes horizontal or vertical blanking periods in a display frame where display updating is paused (i.e., display signals are not driven on the gate lines, source lines, etc.). During these times (e.g., before updating the first display line of a display or after updating the last display line of the display), the input device may continue to drive capacitive sensing signals onto the sensor electrodes to avoid updating display lines where sensing occurs.

In other embodiments, the sensing electrodes and the display update electrodes may be simultaneously driven with modulated voltages, such that both display updating and capacitive sensing occur over the same display line. For example, the spatial separation technique illustrated in chart 700 is combined with one of the frequency synchronization and phase alignment techniques described in FIGS. 6A and 6B. That is, an input device may perform a combination of these techniques to mitigate the affect periodic noise events caused by the display electrodes may have on the sensor electrodes. For example, although the technique illustrated in chart 700 is effective at preventing noise from the gate lines from affecting sensor electrodes, the source lines are all on simultaneously during each line update, and thus, spatially avoiding the noise from the source lines may be impossible (although some source line updates may be staggered to avoid such interference). Stated differently, no matter which sensor electrode is selected, the sensor electrode will be proximate to a source line, and thus, be affected by the noise events on the proximate source lines such as charge share events or other voltage transitions. Thus, the input device may perform spatial separation to avoid the noise cause by the gate lines and also perform frequency synchronization and phase alignment to mitigate the noise events caused by source lines. In addition, as discussed in FIGS. 6A and 6B, performing frequency synchronization and phase alignment may also further mitigate any noise from the gate lines on the sensor electrodes.

FIGS. 8A-8D illustrate performing capacitive sensing in portions of a display that are spatially separated from active gate lines, according to one embodiment described herein. FIGS. 8A-8D illustrate different regions of a display screen 800 that are used for display updating and capacitive sensing. The simplified display screen 800 includes four gate lines (G1, G2, G3, and G4) which define the rows in the screen 800. Each of the FIGS. 8A-8D illustrate one line update where one of the gate lines is active. As shown in FIG. 8A, G1 is HIGH (i.e., active) which permits the source drivers and source lines (not shown) to update the voltages across the pixels in the row activated by G1. The input device defines a region 810 that indicates where capacitive sensing should not take place. Although the region 810 is shown as including only gate line 810 (and the surrounding region) it may include multiple gate lines to provide an additional separation buffer and/or multiple gate lines may be driven high (e.g., overlapped gate driving).

In one embodiment, the input device may avoid receiving resulting sensing signals on any sensor electrodes within region 810. Instead, the input device performs capacitive signal in region 815 which may include one or more sensor electrodes (e.g., sensor electrodes that are parallel to the gate lines as shown in FIG. 2A or one or more block electrodes arranged as capacitance sensing pixels as shown in FIG. 2B). Thus, the sensor electrodes in region 815 are physically separated from the active gate line G1. In addition to separating the active gate line from the sensor electrodes, the input device may synchronize the frequency of the capacitive sensing signal with the line rate as well as phase aligning the display signals and the sensing signal as discussed above. In one embodiment, the entire panel may be driven to operate as a guard while at least a portion of the sensor electrodes are driven for input sensing.

FIG. 8B illustrates the subsequent line update where now G2 is active and G1 is inactive. Of course, if gate line pipelining were used, G2 may have been activated during the line update shown in FIG. 8A so that the signal has settled when performing the line update shown in FIG. 8B. Here, input device defines a region 825 around G2 indicating where no capacitive sensing should occur. As such, the input device may choose to drive the capacitive sensing signal on sensor electrodes with region 830. FIGS. 8C and 8D also illustrate subsequent line updates that define exclusion regions 845 and 860, respectively, where the input device should not perform capacitive sensing. Moreover, although the regions 815, 830, 840, and 855 where capacitive sensing is performed in FIGS. 8A-8D are shown as having the same area as the exclusion regions 810, 825, 845, and 860 this is not a requirement. Indeed, the regions 815, 830, 840, and 855 will be larger than regions 810, 825, 845, and 860 if multiple capacitive frames are determined during each display frame. Moreover, the regions 815, 830, 840, and 855 are shown as being contiguous, but may in fact includes regions of the display screen that are above and beneath the exclusion regions 815, 830, 840, and 855. That is, during a line update, the input device may perform capacitive sensing on sensor electrodes that are both above and below the currently active gate line.

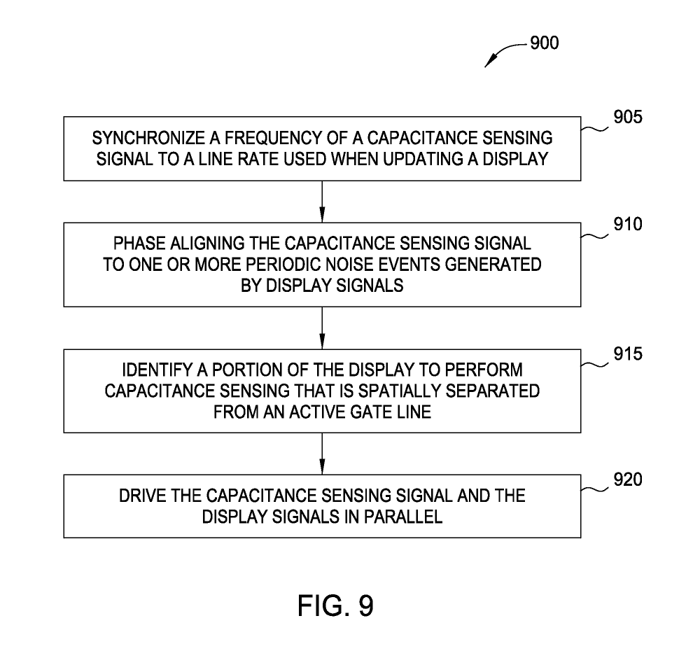

FIG. 9 illustrates a method 900 for performing capacitive sensing and display updating in parallel, according to one embodiment described herein. At block 905, an input device synchronizes a frequency of the capacitive sensing signal used to perform capacitive sensing (e.g., absolute capacitance sensing or transcapacitive sensing) to the line rate used by the input device to update an integrated display.

In one embodiment, the capacitance sensing signal includes a plurality of sensing cycles that each contain two half cycles. The half cycles may be synchronized to the line rate used when updating the display. For example, the time period of the half cycle may be an integer multiple of the time period used to perform a line update. For example, the time period of the half cycle may be four times longer than the time period of the line update or vice versa.

At block 910, the input device phase aligns the capacitance sensing signal to one or more periodic noise events generated by the display signals. In the examples shown in FIGS. 6A and 6B, the capacitance sensing signal is aligned with the source driver outputs such that the charge share event, source line enable, and/or gate line driving may align with the reset period in the demodulated signal. Notably, because the noise event (e.g., the charge share event, source line enable, and/or gate line driving) consistently falls within the reset period, any noise from this event is not recorded in the sampled demodulated signal. In such embodiments, the beginning and the end of the reset times are at a stable voltage. Nonetheless, other phase alignments are possible and still mitigate or prevent the noise event from affecting capacitive sensing. In one example, the noise may be mitigated so long as the noise event consistently falls within the same period of the demodulation signal. In various embodiments, any noise that averages out over the number of lines (and demodulated cycles) in the filtered measurements also does not affect the filtered measurements. For instance, it is equally permissible to phase align the signals such that the charge event and/or source output enable always falls within one of the positive or negative integration periods.

In another embodiment, instead of synchronizing phase and frequency such that the periodic noise event occurs in the same period in each sensing cycle, in one sensing cycle the noise event occurs in the positive integration period but in a subsequent sensing cycle the noise event occurs in the negative integration period. In another embodiment, the display and capacitive signals may be synchronized so that the up and down transitions (e.g., offsetting positive and negative polarities) of a noise event occur in the same half cycle. Furthermore, in another embodiment, display and capacitive sensing signals may be synchronized and phase aligned such that the same number of up transitions of a noise event (e.g., from a low voltage to a higher voltage) may all occur in the positive integration period and the same number of down transitions (e.g., from a high voltage to a lower voltage) occur in the positive integration period (and vice versa for negative integration periods). Like above, once the samples are filtered, the contribution of charge from the noise event does not indicate a change of capacitance, and thus, is not interpreted as a proximate input object. In many embodiments, various demodulation waveforms may be used (e.g., sinusoidal sinc or matched filters), not being limited to square-wave demodulation.

At block 915, the input device identifies a portion of the display to perform capacitance sensing that is spatially separated from an active gate line used for display updating. For example, the sensor electrode chosen for carrying the capacitance sensing signal may be located outside of a region surrounding the active gate line as discussed in FIGS. 7 and 8A-8D above.

At block 920, the input device drives the capacitance sensing signal onto at least one sensor electrode in parallel with driving the display signal onto at least one display electrode. That is, there exists at least some time period when the input device is simultaneously performing capacitive sensing and display updating. However, it is not a requirement that the input device always be performing these two task simultaneously. There may be times where the input device is doing one of the tasks but not the other such as during a display blanking time or during a noise measurement time.

### CONCLUSION

Various embodiments of the present technology provide input devices and methods for improving usability. In one embodiment, an input device with an integrated display drives a capacitance sensing signal on a sensor electrode in parallel with driving a display signal onto a display electrode. To mitigate the interference between the two signals, the input device synchronizes the frequency of the capacitance sensing signal to a line rate used when performing display updating—i.e., the time period used by the integrated display to update a row of pixels. In addition, in one embodiment, the input device may phase align the capacitance sensing signal with a periodic noise event in the display signal such as a voltage transition, charge share event, and the like. By synchronizing and phase aligning the capacitance sensing signal and display signal, the input device may prevent the noise events from indicating a change of capacitance (which may be misinterpreted as being caused by an input object proximate to the integrated display) when the capacitance sensing signal is sampled and filtered.

In another embodiment, the input device may perform capacitance sensing on a sensor electrode that is spatially separated from a display electrode that is currently active. When updating the display, the input device may raster through each row consecutively by activating respective gate lines. To avoid interference between the signals on the gate lines and the capacitive sensing signal on a sensor electrode, the input device may perform capacitive sensing on a sensor electrode that is spatially separated from the active gate line where the device is currently updating the pixels.

The embodiments and examples set forth herein were presented in order to best explain the embodiments in accordance with the present technology and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

In view of the foregoing, the scope of the present disclosure is determined by the claims that follow.

We claim:

1. An input device comprising:
a plurality of display electrodes;
a plurality of sensor electrodes; and
a processing system coupled to the plurality of sensor and display electrodes, the processing system is configured to:
drive a capacitive sensing signal onto at least one of the plurality of sensor electrodes; and
drive a display signal onto at least one of the plurality of display electrodes for updating the display,
wherein the capacitive sensing signal and the display signal are driven in parallel for at least some period of time, and
wherein a frequency of the capacitive sensing signal is synchronized to a line rate used by the display module when updating the display.

2. The input device of claim 1, wherein the frequency of the capacitive sensing signal defines a sensing cycle comprising two half cycles, wherein a duration of the half cycles is synchronized to the line rate.

3. The input device of claim 2, wherein the duration of the half cycles is different from a duration of the line rate.

4. The input device of claim 3, wherein the duration of the half cycles is an integer multiple of a duration of the line rate.

5. The input device of claim 1, wherein the capacitive sensing signal is phase aligned with a periodic event occurring when updating the display using the plurality of display electrodes such that the periodic event predicatively occurs in a same period of a plurality of sensing cycles in the capacitive sensing signal.

6. The input device of claim 1, wherein at least one of the plurality of display electrode is a gate line used to activate a row of pixels in the display, wherein at least one of the plurality of sensor electrodes driven with the capacitive sensing signal is spatially separated from the gate line such that the gate line and the at least one sensor electrode do not overlap on the display.

7. The input device of claim 1, wherein at least one of the plurality of sensor electrodes comprises at least one of the plurality of display electrodes.

8. A processing system, comprising:
a sensing module configured to drive a capacitive sensing signal onto at least one of a plurality of sensor electrodes; and
a display module configured to drive a display signal onto at least one of a plurality of display electrodes for updating a display,
wherein the capacitive sensing signal and the display signal are driven in parallel for at least some period of time, and
wherein a frequency of the capacitive sensing signal is synchronized to a line rate used by the display module when updating the display.

9. The processing system of claim 8, wherein the frequency of the capacitive sensing signal defines a sensing cycle comprising two half cycles, wherein a duration of the half cycles is synchronized to the line rate.

10. The processing system of claim 9, wherein the duration of the half cycles is different from a duration of the line rate.

11. The processing system of claim 10, wherein the duration of the half cycles is an integer multiple of a duration of the line rate.

12. The processing system of claim 8, wherein the capacitive sensing signal is phase aligned with a periodic event occurring when updating the display using the at least one display electrode such that the periodic event predicatively occurs in a same period of a plurality of sensing cycles in the capacitive sensing signal.

13. The processing system of claim 8, wherein the at least one display electrode is a gate line used to activate a row of pixels in the display, wherein the capacitive sensing module is configured to select the at least one sensor electrode from the plurality of sensor electrodes so that the at least one sensor electrode is spatially separated from the gate line such that the gate line and the at least one sensor electrode do not overlap on the display.

14. The processing system of claim 8, wherein the capacitive sensing module and the display module are within a same integrated circuit.

15. A method, comprising:
driving a capacitive sensing signal onto at least one of a plurality of sensor electrodes; and
driving a display signal used for updating a display onto at least one of a plurality of display electrodes, wherein the capacitive sensing signal and display signal are driven in parallel for at least some period of time,
wherein a frequency of the capacitive sensing signal is synchronized to a line rate used when updating the display.

16. The method of claim 15, wherein the frequency of the capacitive sensing signal defines a sensing cycle comprising two half cycles, wherein a duration of the half cycles is synchronized to the line rate.

17. The method of claim 16, wherein the duration of the half cycles is different from a duration of the line rate.

18. The method of claim 15, further comprising phase aligning the capacitive sensing signal with a periodic event occurring when updating the display using the at least one display electrode such that the periodic event predicatively occurs in a same period of a plurality of sensing cycles in the capacitive sensing signal.

19. The method of claim 15, wherein the at least one display electrode is a gate line used to activate a row of pixels in the display, the method further comprising:
selecting the at least one sensor electrode from the plurality of sensor electrodes so that the at least one sensor electrode is spatially separated from the gate line such that the gate line and the at least one sensor electrode do not overlap on the display.

20. The method of claim 15, further comprising:
driving a different display signal used for updating the display onto at least one display electrode within the at least one sensor electrode, wherein driving the capacitive sensing signal does not overlap with driving the different display signal.

21. The method of claim 15, wherein at least one of the plurality of sensor electrodes used for performing capacitive sensing comprises at least one of the plurality of display electrodes used for updating the display.
